(19) United States
(12) Patent Application Publication
(10) Pub. No.: US 2019/0136811 A1
(43) Pub. Date: May 9, 2019

(54) INJECTION SYSTEM, IN PARTICULAR FUEL INJECTION SYSTEM, HAVING A FLUID-CONVEYING COMPONENT, A METERING VALVE, AND A MOUNTING SYSTEM

(71) Applicant: Robert Bosch GmbH, Stuttgart (DE)

(72) Inventors: Andreas Rehwald, Bietigheim-Bissingen (DE); Prakash Gurushantappa Yadawad, Stuttgart (DE); Rao Bharath Narahari, Mysuru City (IN); Sunil Makarabbi, Haveri (IN)

(21) Appl. No.: 16/177,935

(22) Filed: Nov. 1, 2018

(30) Foreign Application Priority Data
Nov. 6, 2017 (DE) 102017219628.9

(51) Int. Cl. F02M 61/14; F02M 55/02

(52) U.S. Cl. CPC F02M 61/14; F02M 2200/853; F02M 2200/09; F02M 55/025

(57) ABSTRACT

A mounting system for injection systems serves to connect a fuel injection valve to a fluid-conveying component. In the installed state, a connector piece of the metering valve is inserted at least partly into a receiving space of a connector body of the component. A support part is disposed on the connector piece. The connector piece of the fuel injection valve is mounted on the connector body in the installed state via the support part, a decoupling element, and a fastening body. The abutment body is retained by the fastening body in such a way that the abutment body is movable radially with respect to the longitudinal axis at least in the context of installation relative to the fastening body.

### FIELD OF THE INVENTION

The invention relates to a mounting system for injection systems, in particular fuel injection systems, for connecting a metering valve to a fluid-conveying component; and to an injection system having such a mounting system. The invention relates in particular to the field of fuel injection systems for mixture-compressing spark-ignited internal combustion engines.

### BACKGROUND INFORMATION

German Published Patent Application No. 10 2013 200 993 discloses a fuel injection system having a fuel-conveying component, a fuel injection valve, and a mounting system. In the known mounting system, a receiving space, in which a fuel fitting of the fuel injection valve is disposed, is provided inside a cup of the fuel-conveying component. An internal collar is configured on the cup. Also provided is an elastically deformable element that is braced against the internal collar. The fuel fitting is then braced via the elastically deformable element. Mounting of the fuel injection valve on the fuel-conveying component is thereby possible, a reduction in noise being possible as a result of targeted decoupling.

Reducing engine noise is important nowadays not only in terms of noise perceptible in the vehicle interior. In the context of a sales discussion, certain engine noises can be perceived by a customer as undesirable when the engine is idling, especially with the hood open. This relates in particular to metallic transitions in the context of the fuel injection valve mounting system. It can furthermore be assumed that as fuel injection pressure increases, such undesired noises will be at least subjectively perceived to be louder.

### SUMMARY

The mounting system according to the present invention, and the injection system, have the advantage that improved mounting of the metering valve on the fluid-conveying component is made possible. In particular, improved installation at least with reference to suitable application instances can be achieved.

The mounting system and the injection system are suitable especially for applications for fuel injection, in particular direct gasoline injection. The fluid-conveying component is then embodied as a fuel-conveying component. The metering valve is then embodied as a fuel injection valve. The advantages and refinements described with reference to these preferred applications can, however, also correspondingly be utilized generally in a mounting system for injection systems and in injection systems.

The fuel-conveying component is preferably embodied for that purpose as a fuel distributor, in particular as a fuel distributor bar. A fuel distributor of this kind can serve on the one hand to distribute fuel to several fuel injection valves, in particular high-pressure injection valves. On the other hand, the fuel distributor can serve as a common fuel reservoir for the fuel injection valves. The fuel injection valves are then preferably connected to the fuel distributor via corresponding mounting systems. During operation, the fuel injection valves then inject the fuel necessary for the combustion operation, at high pressure, into the respective combustion chamber. The fuel is compressed via a high-pressure pump and delivered into the fuel distributor in quantitatively controlled fashion via a high-pressure conduit.

The support part disposed on the connector piece is preferably embodied as a separate support part that can be connected in suitable fashion to the connector piece of the injection valve. In principle, the support part can also be a constituent of the connector piece. The connector piece is thus not necessarily a constituent of a mounting system according to the present invention. In particular, a mounting system according to the present invention can, if applicable, also be manufactured and marketed separately from the fuel injection valve. The connector body can be a constituent of the fuel-conveying component. In particular, the connector body can be configured as a cup of a fuel distributor. The connector body can, however, also be connected at a later time to a base body of a fuel distributor, for example by welding. A mounting system according to the present invention can thus, if applicable, also be manufactured and marketed independently of such further components, in particular a base body, of the fuel-conveying component.

With an advantageous refinement, the bracing can be implemented particularly advantageously in particular with reference to compensation for positional tolerances of the installed fuel injection valve. Compensation for positional errors with reference to an ideal position of the fuel injection valve is thereby made possible, at least in the context of installation, by way of a radial movability of the abutment body and pivotability of the fuel injection valve on the spherical abutment surface of the abutment body. The fuel injection valve, which in the installed state is on the one hand mounted on the connector body and on the other hand, for example, inserted into a cylinder-head orifice, can thereby be installed with no stress or at least with reduced stress.

In a possible embodiment, it is advantageous that the support part has a spherical support surface; that a spherical abutment surface that faces toward the spherical support surface of the support part is provided; and that the decoupling element is disposed between the spherical support surface of the support part and the spherical abutment surface of the abutment body.

The abutment body is preferably configured so that its spherical abutment surface is part of a sphere surface or part of a surface of a sphere segment. The spherical support surface is correspondingly embodied respectively as part of a sphere surface or as part of a surface of a sphere segment. The decoupling element preferably abuts at least largely against the entire spherical abutment surface of the fastening body and/or at least largely against the entire spherical support surface of the support part.

In a possible embodiment, it is advantageous that the decoupling element abuts in the installed state at least substantially with full coverage against the spherical support surface of the support part and/or at least substantially with full coverage against the spherical abutment surface. Local mechanical loads are thereby reduced. Improved geometric alignment and bracing in different spatial directions can furthermore be achieved. In particular, advantageous alignment and bracing of the fuel injection valve with reference to a longitudinal axis predefined by the connector body can be enabled. This also results in improved positioning of the fuel injection valve in, for example, a cylinder orifice of the internal combustion engine.

The advantage thereby obtained is that mechanical transitions, in particular metal-on-metal, can be avoided a priori. The result obtained thereby can be in particular that a direct transfer path between the fuel injection valve and a fuel distributor is absent. A further result that can be obtained by way of the mounting system is that a direct transfer path between the fuel injection valve and a cylinder head is absent. Fastening means between the fuel injection valve and the cylinder head, for example bolts that are inserted into elastic bearing bushings for noise insulation, can thereby also be absent.

Advantageously, in an advantageous embodiment, fastening body segments, in particular fastening body halves, of a segmented fastening body are installed radially, i.e. perpendicularly to a longitudinal axis of the connector body, upon installation. Also possible, however, is installation along the longitudinal axis, i.e. in the joining direction of the connector piece of the fuel injection valve.

A further refinement has the advantage that the fastening body, which is assembled from two or more fastening body segments, in particular two fastening body halves, is held together via the retaining element. In a preferred embodiment of the fastening body segments, the retaining element, preferably configured as a fastening ring, needs to absorb only small forces. That is the case in particular when each of the fastening body segments is refined, since forces acting in particular along the longitudinal axis are then absorbed by way of the positive engagement of the respective fastening body segment with the connector body. Stress on the fastening ring can thus be at least largely relieved.

A further refinement has the advantage of enabling a compact configuration of a fastening body segment and at the same time, if applicable, disposition of the surrounding depression in only those fastening body segments which make up the fastening body. With such an embodiment, insertion of the tenon into the groove, which preferably occurs radially with respect to the longitudinal axis, can furthermore be limited by a stop on the connector body, thus resulting in a defined installation position for the fastening body segment. Absorption of transverse forces in the installed state can then also be effected by way of the positive engagement. It is thereby possible to at least largely relieve stresses, with reference to forces necessary during operation for retaining the fuel injection valve, on a retaining element, in particular a fastening ring, that may be provided.

A further embodiment is additionally or alternatively advantageous. With such an embodiment it is possible in particular to achieve securing of the mounting body and if applicable also of mounting body segments, with respect to a load acting along the longitudinal axis relative to the connector body.

It is advantageous that the decoupling element is configured as part of a hollow sphere, in particular as a perforated hollow sphere cap. With this refinement, in particular, an at least approximately constant thickness of the decoupling element in the unloaded state can be defined.

It is advantageous that the decoupling element is constituted at least partly from an elastic material. With this configuration of the decoupling element it is advantageous in particular if the decoupling element is constituted at least partly from at least one elastomer. The decoupling element can be shaped at least partly as a net-shape shaped part, in particular as a plastic injection-molded part, a thermoplastic elastomer part, a natural rubber part, or a synthetic rubber part, and/or can be cut out from a strip- or plate-shaped precursor material and/or shaped in another manner.

Additionally or alternatively, the decoupling element can be constituted at least partly from a thermoplastic material or a curable plastic material. In particular, the decoupling element can advantageously have a layered structure, in particular a sandwich structure. It is particularly advantageous that the decoupling element has a layered structure, in particular a sandwich structure, having at least one elastic intermediate layer. A layered structure is not necessarily limited in this context to two or three layers. A layered structure in which an elastic layer is located between two non-elastic layers is nevertheless advantageous.

It is advantageous that the decoupling element has a first outer layer that is embodied as a metallic layer or as an at least substantially inelastic plastic layer, and a second outer layer that is embodied as a metallic layer or as an at least substantially inelastic plastic layer; and that the elastic intermediate layer is disposed between the first outer layer and the second outer layer. This refinement has the particular advantage that both good robustness and an advantageous damping effect can be achieved.

It is advantageous that the decoupling element is configured as a metallic spring element. This refinement has the advantage that a solid and robust configuration of the decoupling element is possible.

In a possible embodiment, it is conceivable for the fastening body to be embodied as a deep-drawn fastening body. Simple installation of the fuel injection valve can thereby be enabled. Upon insertion of the connector piece of the fuel injection valve into the receiving space of the connector body, the fastening body can also be joined to the connector body and then immobilized in simple fashion. Fastening of the connector piece onto the connector body of the component is thereby effected. Together with the fuel pressure that acts during operation, reliable immobilization of the fuel injection valve is then produced because forces acting on the connector piece by way of the fuel pressure are absorbed via the fastening body connected to the connector body. According to this refinement, the fastening body can be embodied as a deep-drawn part.

### BRIEF DESCRIPTION OF THE DRAWINGS

FIG. 1 is a partial schematic sectioned depiction of a fuel injection system having a mounting system, in accordance with a first exemplifying embodiment of the invention.

FIG. 2 shows a decoupling element of the mounting system depicted in FIG. 1, in accordance with a first possible embodiment.

FIG. 3 shows a decoupling element of the mounting system depicted in FIG. 1, in accordance with a second possible embodiment.

FIG. 4 shows a decoupling element of the mounting system depicted in FIG. 1, in accordance with a third possible embodiment.

FIG. 5 shows a decoupling element of the mounting system depicted in FIG. 1, in accordance with a fourth possible embodiment.

FIG. 6 shows a support part of the mounting system depicted in FIG. 1, in accordance with a possible embodiment.

FIG. 7 is a three-dimensional sectioned depiction of the support part depicted in FIG. 6, a longitudinal axis being located in the section plane.

FIG. 8 shows a fastening body of the mounting system depicted in FIG. 1, in accordance with a preferred embodiment.

FIG. 9 is a partial depiction of the mounting system depicted in FIG. 1, having a fastening body and a connector body, in accordance with the preferred embodiment.

FIG. 10 shows an abutment body of the mounting system depicted in FIG. 1, in accordance with a possible embodiment.

FIG. 11 is a three-dimensional sectioned depiction of the abutment body depicted in FIG. 10, a longitudinal axis being located in the section plane.

FIG. 12 is a partial schematic depiction of a fuel injection system having a mounting system, in accordance with a second exemplifying embodiment of the invention.

FIG. 13 is a partial three-dimensional depiction of the fuel injection system shown in FIG. 12, during installation.

FIG. 14 is a partial schematic sectioned depiction of the mounting system of the fuel injection system shown in FIG. 12.

FIG. 15 shows a fastening body segment of a fastening body of a mounting system of the fuel injection system shown in FIG. 12.

FIG. 16 shows a retaining element, configured as a fastening ring, of a mounting system of the fuel injection system shown in FIG. 12.

### DETAILED DESCRIPTION

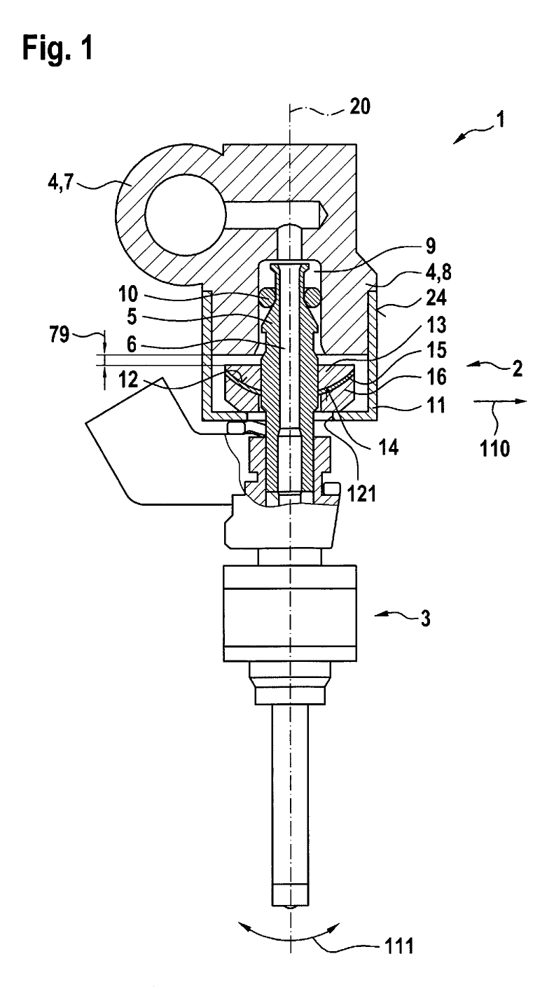

FIG. 1 is a partial schematic sectioned depiction of a fuel injection system 1 having a mounting system 2, in accordance with a first exemplifying embodiment. Fuel injection system 1 has a fuel injection valve 3 and a fuel-conveying component 4. Fuel injection valve 3 has a connector piece 5 that encompasses an axial passthrough orifice 6 in order to convey fuel into fuel injection valve 3. In this exemplifying embodiment, fuel-conveying component 4 has a tubular base body 7 and a connector body 8. In this exemplifying embodiment, connector body 8 is embodied as a cup 8 and has a receiving space 9.

Connector piece 5 is inserted at least partly into receiving space 9 of connector body 8. Fuel sealing is ensured in this context by way of a sealing ring 10.

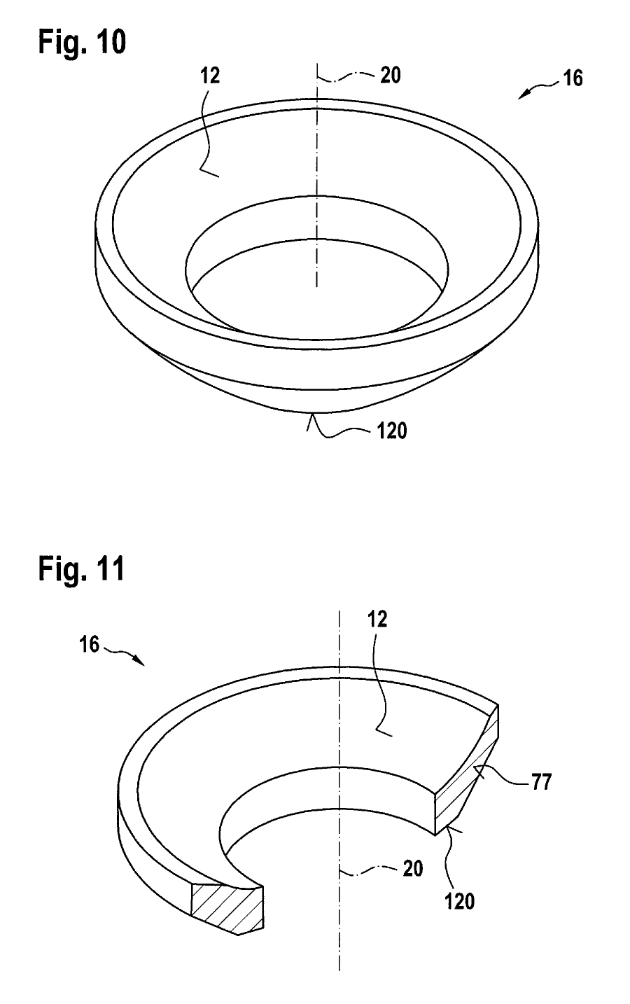

A fastening body 11, which serves for fastening of an abutment body 16, is also installed. A spherical abutment surface 12 (FIG. 10) is embodied on the abutment body. In this exemplifying embodiment, a support part 13 that is connected to connector piece 5 is furthermore disposed on connector piece 5. In a modified embodiment, support part 13 can in principle also be a constituent of connector piece 5. A spherical support surface 14 (FIG. 5), which faces toward spherical abutment surface 12, is embodied on support part 13.

In the installed state, a decoupling element 15 is disposed between spherical abutment surface 12 of fastening body 11 and spherical support surface 14 of support part 13. Decoupling element 15 preferably abuts substantially against the entire spherical abutment surface 12 and/or at least substantially against the entire spherical support surface 14, so that at least substantially full-coverage abutment of decoupling element 15 on both sides, respectively against spherical abutment surface 12 or spherical support surface 14, is produced.

Abutment body 16 is disposed in fastening body 11 in such a way that at least upon installation, a certain movability of abutment body 16 in a radial direction 110 with respect to a longitudinal axis 20 of receiving space 9 is made possible. This makes possible, especially upon installation, a positional compensation that serves to compensate for positional errors. Configuring decoupled bracing via decoupling element 15 furthermore ensures, at least upon installation, a certain tilting of an alignment of fuel injection valve 3 with reference to longitudinal axis 20, as illustrated in FIG. 1 by a double arrow 111. As a result of the movability in any radial direction 110 with reference to longitudinal axis 20, and thanks to the capability for tilting 111, reduced-stress and preferably at least substantially stress-free installation of fuel injection valve 3 can, in particular, be achieved. Fastening body 11 has a preferably circular opening 121 through which connector piece 5 extends in the installed state. A size, in particular a diameter, of opening 121 is predefined to be sufficiently large that direct contact does not occur between connector piece 5 and fastening body 11 in a context of practically possible changes in the position of connector piece 5. Advantageously, the sealing by way of elastic sealing ring 10 between connector piece 5 of fuel injection valve 3 and connector body 8 of component 4 can enable that compensation, and can ensure reliable sealing by way of the requisite freedom of movement. Mounting system 2 is configured in such a way that direct metal-on-metal contact, in particular between connector piece 5 and connector body 8, is prevented by way of the predefined freedom of movement.

In the installed state, fuel injection valve 3 is then aligned with reference to longitudinal axis 20, predefined by connector body 8, of receiving space 9. Reliable positioning of fuel injection valve 3 in a cylinder-head orifice can correspondingly be accomplished, for example. Mounting system 2 makes additional fastening or bracing (by way of a metallic contact) of fuel injection valve 3 against the cylinder head superfluous. Transfer of vibrations between fuel injection valve 3 and the cylinder head is thereby, in particular, avoided. Insulation of fuel injection valve 3 from connector body 8 and thus from fuel-conveying component 4 is furthermore provided by decoupling element 15. This reduces or prevents, in particular, the transmission of solid-borne sound.

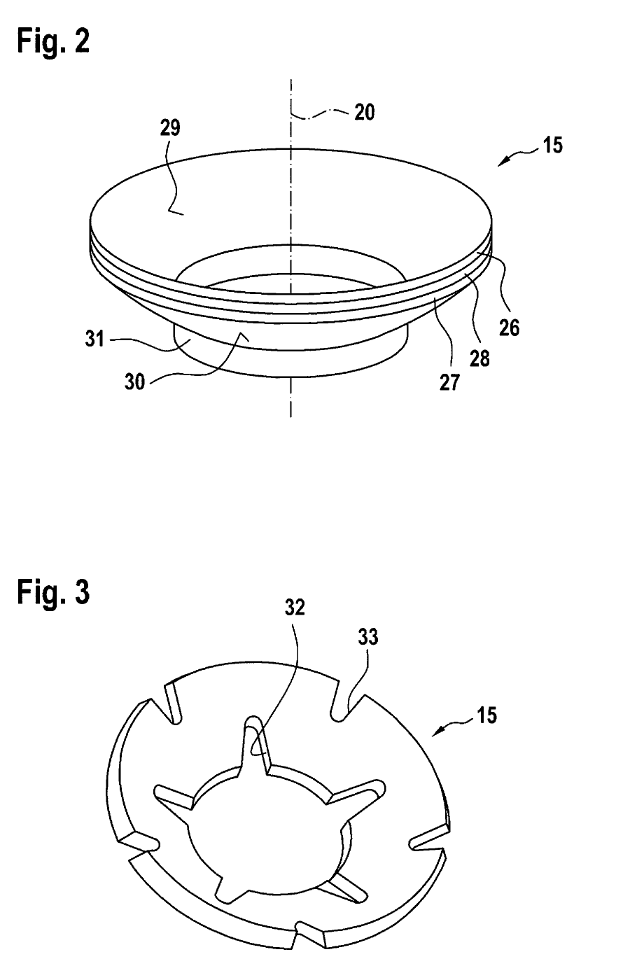

FIG. 2 is a schematic three-dimensional depiction of a decoupling element 15 of the mounting system depicted in FIG. 1, according to a first possible embodiment. In this embodiment, layers 26, 27, 28 are provided. Layer 28 is preferably embodied as an elastic intermediate layer in order to enable a sandwich structure. Layer 26 serves here as a first outer layer 26, and layer 27 serves as a second outer layer 27. Layers 26, 27 are preferably embodied as metallic layers 26, 27 and/or as at least substantially inelastic plastic layers. Improved stability at an outer side 29 of layer 26 and at an outer side 30 of layer 27 can thereby, in particular, be achieved. Outer side 29 abuts in the installed state against spherical support surface 14 of support part 13. Outer side 30 abuts in the installed state against spherical abutment surface 12 of fastening body 11. A collar 31, which surrounds connector piece 5 in portions in the installed state, can also be shaped onto decoupling element 15 in order also to ensure insulation with respect to fastening body 11 in a radial direction with reference to longitudinal axis 20. Collar 31 can furthermore ensure positioning of decoupling element 15 on fastening body 11.

FIG. 3 shows the decoupling element depicted in FIG. 2 in accordance with a second possible embodiment. In this embodiment, decoupling element 15 is configured as a metallic spring element 15. Recesses 32, 33 (only recesses 32, 33 of which are labeled in order to simplify the depiction) can be provided on decoupling element 15 in addition to a three-dimensional configuration in order to define the elastic effect desired in the particular application instance, in particular a spring constant.

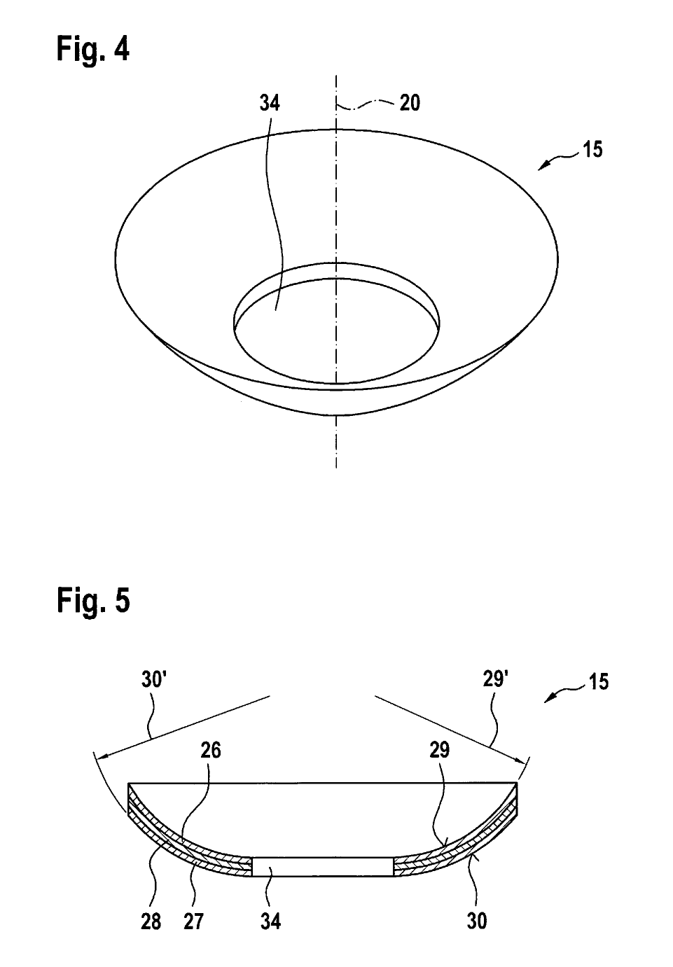

FIG. 4 shows the decoupling element depicted in FIG. 2 in accordance with a third possible configuration. Decoupling element 15 can be configured here, for example, as a shaped element generated in a tool. An axial opening 34, which can be of circular configuration and is oriented with reference to longitudinal axis 20 defined in the installed state, can also be embodied, for example, by punching.

FIG. 5 is a schematic sectioned depiction of a decoupling element 15 of mounting system 2 depicted in FIG. 1, in accordance with a fourth possible embodiment. In this exemplifying embodiment, decoupling element 15 has at least approximately spherically configured layers 26, 27, 28. Outer side 29 can especially be equipped thereby with a radius 29′. Outer side 30 can correspondingly be equipped with a radius 30′. Axial opening 34 furthermore extends through the three layers 26 to 28. Axial opening 34 can be embodied in particular by way of an axial orifice oriented along longitudinal axis 20.

Several possibilities therefore exist for configuring a decoupling element 15 in terms of the respective application instance. A layered structure having two or more layers, one of which is described with reference to FIG. 2 and another with reference to FIG. 5, can be implemented. Different materials can thereby advantageously be combined. For example, metallic materials and plastics can be combined. A thermoplastic, a thermoplastic elastomer, a natural rubber, and a synthetic rubber can be utilized for an elastic layer, in particular an elastic intermediate layer as explained in FIG. 2 with reference to layer 28, or also in the context of an embodiment made of a single material as described with reference to FIG. 4. A (non-layered) material composition can also be used as a material in this context. In addition, decoupling element 15 does not necessarily need to be installed as a separate component upon installation. Decoupling element 15 can, in particular, already be joined onto fastening body 11. Intermaterial connection or injection application of decoupling element 15 onto fastening body 11 is also conceivable. Decoupling element 15 can also, if applicable in interaction with an elastic sealing ring 10, make possible a certain tolerance compensation for positional deviations of fuel injection valve 3 from longitudinal axis 20. This relates in particular to tilts and to a coaxial offset. Damage to fuel injection valve 3 as a result of flexural forces or the like is thus prevented.

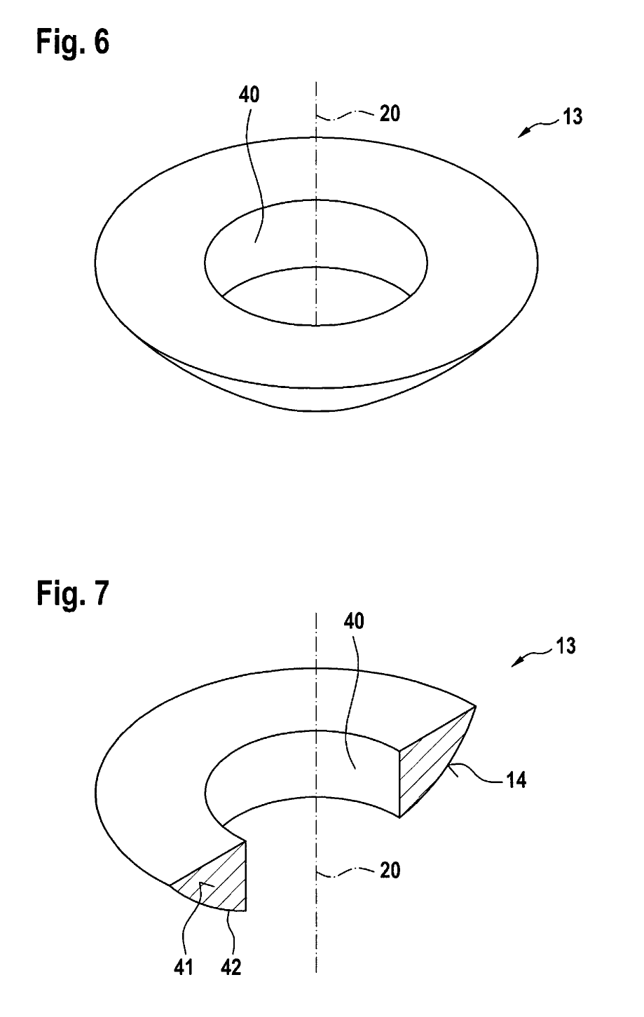

FIG. 6 shows support part 13 of mounting system 2 depicted in FIG. 1, in accordance with a possible embodiment. Support part 13 has a passthrough orifice 40 through which connector piece 5 of fuel injection valve 3 extends in the installed state. Passthrough orifice 40 is configured as an axial passthrough orifice 40 with reference to longitudinal axis 20 predefined by installation. In this exemplifying embodiment, support part 13 is configured annularly with reference to longitudinal axis 20.

FIG. 7 is a three-dimensional sectioned depiction of support part 13 depicted in FIG. 5, longitudinal axis 20 being located in the section plane. Support part 13 is preferably configured with a profile 41 that is uniform in a circumferential direction. A side 42 of profile 41 which adjoins spherical support surface 14 is then embodied in the shape of a circular arc.

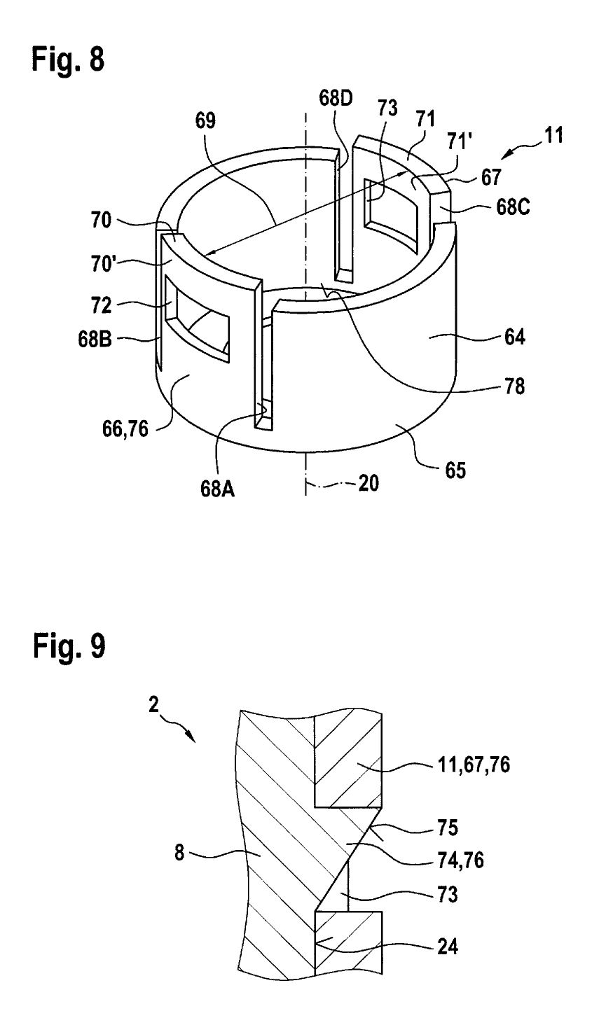

FIG. 8 is a schematic three-dimensional depiction of fastening body 11 of mounting system 2 depicted in FIG. 1, according to a preferred embodiment. Fastening body 11 has a base body 64 on which a fastening ring 65, circumferentially continuous with reference to longitudinal axis 20, is configured. At least one fastening tongue 66, 67 is also configured on base body 64. In this exemplifying embodiment, two fastening tongues 66, 67 that are located oppositely from one another with reference to longitudinal axis 20 are provided. Fastening tongues 66, 67 are separated circumferentially from the remainder of base body 64 by longitudinal slots 68A to 68D. Fastening body 11 is furthermore embodied as a deep-drawn fastening body 11. As a result, fastening tongues 66, 67 are elastically deformable with respect to the remainder of base body 64. In particular, fastening tongues 66, 67 can be spread out away from one another when viewed from longitudinal axis 20, so that a distance 69 between top ends 70, 71 of fastening tongues 66, 67 becomes greater.

In this exemplifying embodiment, cutouts 72, 73 are embodied on fastening tongues 66, 67. As a result, top ends 70, 71 are embodied on webs 70′, 71′. The configuration and manner of operation of mounting system 2 are also described in further detail below with reference to FIG. 9.

FIG. 9 is a partially sectioned detail depiction of mounting system 2; fastening tongue 67 and connector body 8 are depicted in part. Mounting system 2 is depicted in the installed state. A lug 74 is configured on outer side 24 of connector body 8 of component 4. In the installed state, lug 74 engages into cutout 73 of fastening tongue 67. A further lug is correspondingly provided for fastening tongue 66.

Lug 74 has a bevel 75. Upon installation, fastening body 11 is fitted onto connector body 8 along longitudinal axis 20, in which context top end 71 or web 71′ of fastening tongue 67 slides along bevel 75 and causes fastening tongue 67 to spread out. A spreading of fastening tongue 66 correspondingly occurs. When the predefined installation position has been reached, fastening tongue 67 then springs back and lug 74 engages into cutout 73, as depicted schematically in FIG. 9. Because fastening body 11 circumferentially surrounds outer side 24 of connector body 8 at least in portions, fastening body 11 is thereby immobilized on connector body 8 of component 4. Circumferentially acting forces can thereby be absorbed, advantageously in particular via fastening ring 65 of fastening body 11.

An advantageous capability is thereby created for configuring fastening body 11 in part as an elastically deformable fastening body 11. Fastening body 11 is configured in such a way that it is connectable to connector body 8 by way of a snap connection 76 that is described in particular with reference to fastening tongue 67 and lug 64.

Variants in terms of the embodiment of snap connection 76 are also conceivable in this context. For example, a different number of fastening tongues 66, 67 can be provided.

FIG. 10 shows abutment body 16 of mounting system 2 depicted in FIG. 1, according to a possible embodiment. Abutment body 16 here has spherical abutment surface 12 against which decoupling element 15 abuts in the installed state. In the installed state, abutment body 16 is fastened by way of fastening body 11 in such a way that connector piece 5 of fuel injection valve 3 is mounted on connector body 8 by way of support part 13, decoupling element 15, abutment body 16, and fastening body 11. Connector body 8 itself can be connected to the tubular base body 7, for example, by welding.

FIG. 11 is a three-dimensional sectioned depiction of abutment body 16 depicted in FIG. 10, longitudinal axis 20 being located in the section plane. Decoupling element 15 abuts against spherical abutment surface 12. Abutment body 16 furthermore has a side 77, such that spherical abutment surface 12 faces away from side 77. Abutment body 16 can be configured in suitable fashion on side 77. An at least partly conical configuration, which abuts against a correspondingly configured bracing surface 78 of fastening body 11, is particularly useful here. In particular, an alignment of spherical abutment surface 12 along longitudinal axis 20 can be achieved as a result of the interaction of side 77 of abutment body 16 with bracing surface 78 of fastening body 11.

As depicted in FIG. 1, in this exemplifying embodiment abutment body 16 is located outside connector body 8 of component 4 in the installed state when viewed along longitudinal axis 20. In this exemplifying embodiment support part 13, which is connected to connector piece 5 of fuel injection valve 3, is also located outside connector body 8 of component 4 when viewed along longitudinal axis 20. Advantageously, a not insignificant distance 79 is predefined so that by way of the freedom of movement in particular in the context of a tilt 111, direct contact between support part 13 and connector body 8 is prevented. Support part 13 is thus, at least during operation when connector piece 5 is acted upon by the pressure in receiving space 9, disposed at a distance from connector body 8 of component 4 when viewed along longitudinal axis 20. Direct contact, in particular metal-on-metal, is thereby prevented. Mounting mediated by decoupling element 15 can advantageously be implemented here with maximum bearing areas against outer sides 29, 30 of decoupling element 15, so that vibrations can to a large extent be absorbed.

If applicable, individual components, in particular support part 13, decoupling element 15, and abutment body 16 as well as fastening body 11, can be preinstalled on connector piece 5 of fuel injection valve 3. This makes possible simple installation on component 4, in which three-dimensional alignment, in particular along longitudinal axis 20, and immobilization on component 4, are advantageously possible. A sealing test can then be accomplished in the installed state in order to complete installation.

A variety of modifications are possible in terms of the configuration of fuel injection system 1 and of mounting system 2. For example, support part 13 can be connected in suitable fashion to connector part 5 of fuel injection valve 3. Pressing on, welding, or soldering are possible. A loose or detachable connection is, however, also possible. It is also conceivable in this context for the position along longitudinal axis 20 to be adjustable within certain limits and then immobilizable.

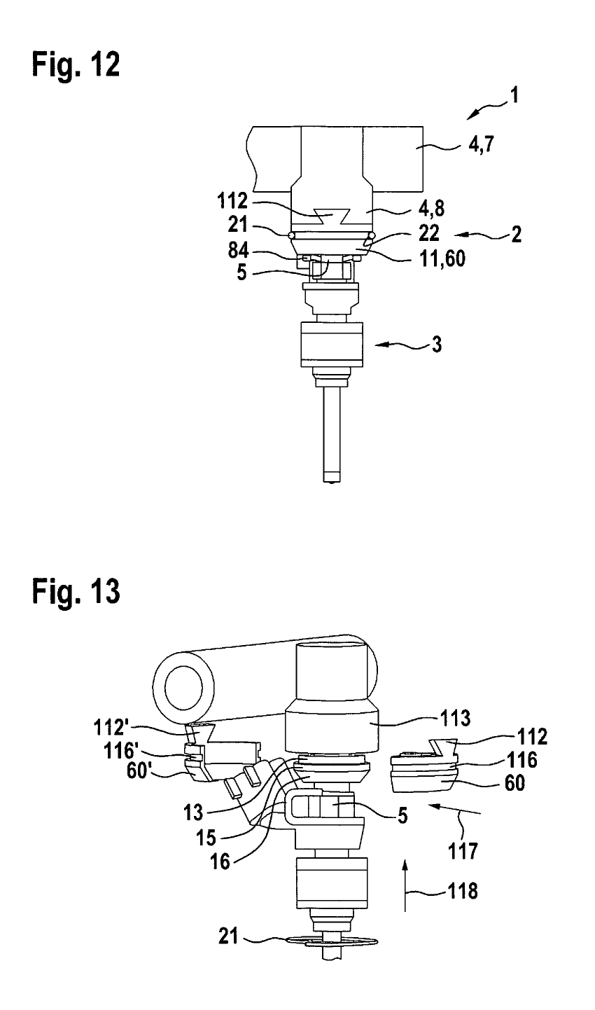

FIG. 12 is a partial schematic depiction of a fuel injection system 1 having a mounting system 2, according to a second exemplifying embodiment. In this exemplifying embodiment, fastening body 11 is embodied as a segmented fastening body 11. Fastening body 11 has several fastening body segments 60. In this exemplifying embodiment, fastening body 11 has two fastening body segments 60, 60′ that are configured as fastening body halves 60, 60′. In this exemplifying embodiment, fastening body halves 60, 60′ are configured correspondingly to one another. Also provided is a retaining clamp 84 that positions fuel injection valve 3 relative to connector body 8. In particular, retaining clamp 84 can specify a defined installation position for fuel injection valve 3 relative to connector body 8.

The configuration of fuel injection system 1 and of mounting system 2 of the second exemplifying embodiment are also described below with reference to FIGS. 13 to 16.

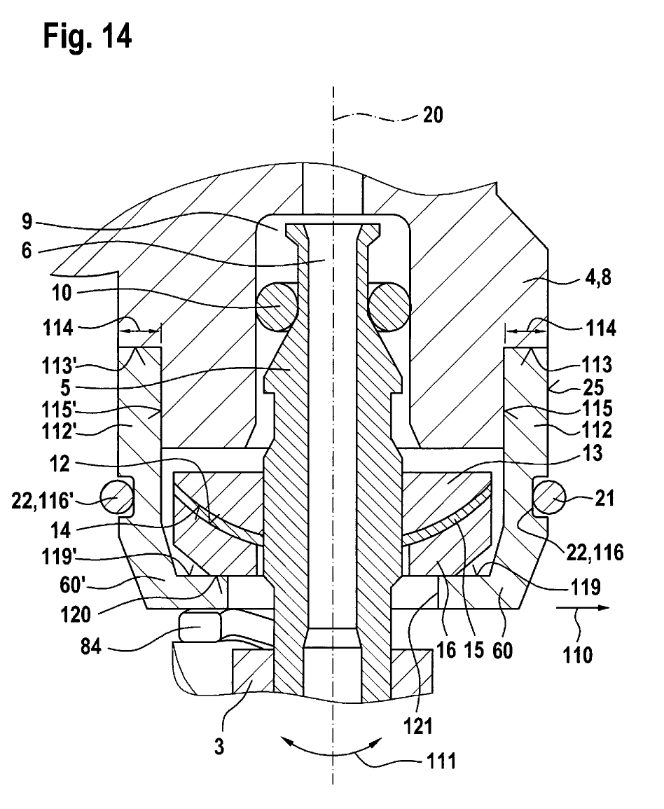

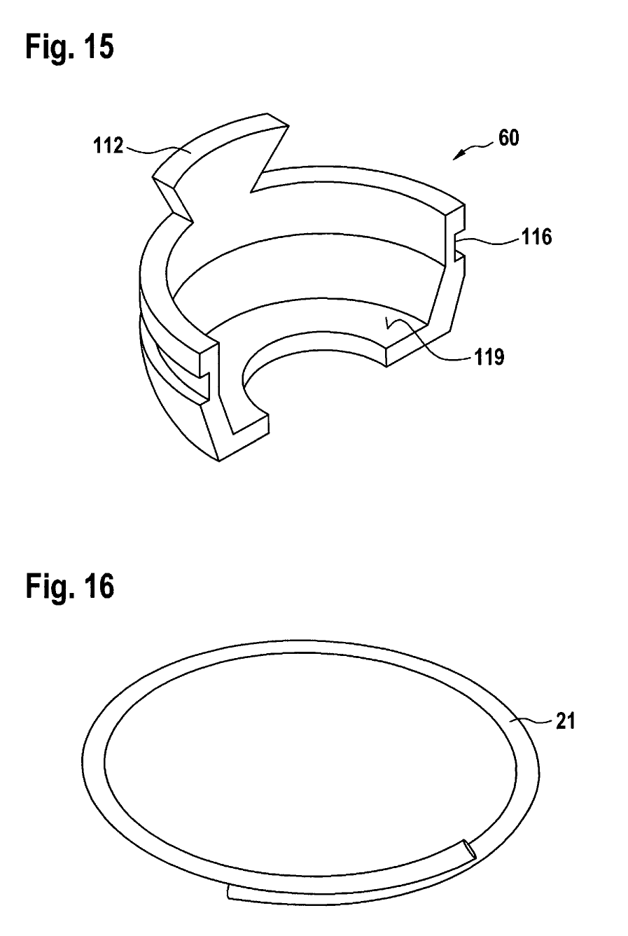

FIG. 13 is a partial three-dimensional depiction of fuel injection system 1 depicted in FIG. 12, upon installation. FIG. 14 is a partial schematic sectioned depiction of mounting system 2 of the fuel injection system of the second exemplifying embodiment shown in FIG. 12. FIG. 15 shows an example of fastening body segment 60, which is embodied as fastening body half 60, of fastening body 11 of mounting system 2 of fuel injection system 1 of the second exemplifying embodiment depicted in FIG. 12. FIG. 16 shows a retaining element 21, configured as a fastening ring 21, of mounting system 2 of fuel injection system 1 of the second exemplifying embodiment shown in FIG. 12. Fastening body half 60 has a tenon 112 that is configured as a dovetail-shaped tenon 112. Fastening body half 60′ correspondingly has a dovetail-shaped tenon 112′. Configured on connector body 8 of component 4 is a groove 113 that is configured so that in the installed state it can receive tenon 112 of fastening body half 60. A groove 113′ is correspondingly configured on connector body 8 for tenon 112′ of fastening body half 60′. In this exemplifying embodiment, grooves 113, 113′ are configured as dovetail-shaped grooves 113, 113′ of connector body 8. A depth 114 to which grooves 113, 113′ extend into connector body 8 is predefined in this context so as to form stops 115, 115′ that limit radial insertion of fastening body halves 60, 60′. In the installed state in which fastening body halves 60, 60′ complement one another to form fastening body 11, the dovetail-shaped tenons 112, 112′ can then abut against stops 115, 115′ of connector body 8. This configuration facilitates installation.

When all the fastening body segments 60, 60′, i.e. in this exemplifying embodiment the two fastening body halves 60, 60′, are disposed on connector body 8, fastening ring 21 is then expanded or spread out in suitable fashion and placed into a peripheral depression 22 of fastening body 11. In the assembled state, fastening body halves 60, 60′ form an outer side 25, preferably of cylindrically enveloping shape, in which depression 22 is configured. In this exemplifying embodiment, semiannular grooves 116, 116′ each extending circumferentially, which combine with one another in the installed state to constitute depression 22, are configured on fastening body halves 60, 60′.

Each of fastening body segments 60, 60′, in particular each of fastening body halves 60, 60′, thereby forms, in the installed state, a positive engagement with connector body 8 when viewed along longitudinal axis 20. Reliable fastening of fastening body 11 onto connector body 8 of component 4 is thus possible.

As depicted in FIG. 13, fastening body halves 60, 60′ can be fitted onto connector body 8 in and oppositely to a radial installation direction 117. In the context of such installation, firstly fuel injection valve 3 can be inserted with its connector piece 5 at least partly into connector body 8 of component 4. Fastening body halves 60, 60′ can then be installed radially. Fastening ring 21 can then be guided over fuel injection valve 3, for example in axial installation direction 118 illustrated in FIG. 13, and placed into depression 22.

As depicted in FIGS. 14 and 15, flat bottom surfaces 119, 119′, which in the installed state are oriented perpendicularly to longitudinal axis 20, are embodied on fastening body halves 60, 60′. A flat underside 120 that faces away from spherical abutment surface 12 is correspondingly configured on abutment body 16. Flat underside 120 is also oriented perpendicularly to longitudinal axis 20. A radial clearance is furthermore predefined between abutment body 16 and fastening body 11 so that abutment body 16 is radially movable in the installed state. Movability in any radial direction 110 with reference to longitudinal axis 20 is thereby preferably enabled. This means that two degrees of freedom between abutment body 16 and fastening body 11 are implemented in order to compensate for positional errors. In addition, a tilt 111 in different planes is possible by way of the mounting of fuel injection valve 3 via support part 13 and decoupling element 15 on abutment body 16. Support part 13 is connected in suitable fashion to connector piece 5 of fuel injection valve 3.

Certain degrees of freedom thereby result upon installation in order to achieve stress-free installation of fuel injection valve 3, and positional errors can be compensated for. Abutment body 16 is retained for that purpose by fastening body 11 in such a way that at least upon installation, abutment body 16 is movable relative to fastening body 11, radially with reference to longitudinal axis 20. Radial direction 110 is depicted as an example thereof. The capabilities for compensating for positional errors which are described with reference to the second exemplifying embodiment can also be implemented in corresponding, or in correspondingly modified, fashion in the context of the first exemplifying embodiment. Suitable combinations are also conceivable. In particular, the embodiment described with reference to FIG. 9 can, if applicable, also be implemented in a context of at least one fastening body segment 60, 60′.

The invention is not limited to the embodiments described.

What is claimed is:

1. A mounting system for an injection system for connecting a metering valve to a fluid-conveying component, comprising:
a connector piece of the metering valve;
a connector body of the component, wherein in an installed state, the connector piece is inserted, along a longitudinal axis predefined by a receiving space of the connector body of the component, at least partly into the receiving space of the connector body of the component;
a support part disposed on the connector piece;
a decoupling element;
an abutment body; and
a fastening body, wherein the connector piece of the metering valve is mounted on the connector body in the installed state via the support part, the decoupling element, the abutment body, and the fastening body, wherein the abutment body is retained by the fastening body in such a way that the abutment body is movable radially with respect to the longitudinal axis at least in a context of installation relative to the fastening body.

2. The mounting system as recited in claim 1, wherein:
the abutment body includes a spherical abutment surface, and
in the installed state, the decoupling element abuts against the spherical abutment surface of the abutment body.

3. The mounting system as recited in claim 1, wherein the fastening body includes several fastening body segments.

4. The mounting system as recited in claim 1, wherein in the installed state, the fastening body is assembled at least from two fastening body segments.

5. The mounting system as recited in claim 3, the fastening body includes in the installed state a cylindrically envelopingly shaped outer side, in which at least one peripheral depression is configured, the mounting system further comprising a retaining element placed into the peripheral depression in the installed state.

6. The mounting system as recited in claim 4, wherein in the installed state, at least one fastening body segment forms a positive engagement with the connector body when viewed along the longitudinal axis.

7. The mounting system as recited in claim 4, wherein:
at least one fastening body segment has at least one tenon,
the connector body includes at least one groove; and
in the installed state, the tenon of the fastening body segment engages positively into the groove of the connector body when viewed along the longitudinal axis.

8. The mounting system as recited in claim 7, wherein:
the tenon is configured as a dovetail-shaped tenon, and
the groove is configured as a dovetail-shaped groove.

9. The mounting system as recited in claim 1, further comprising:
at least one fastening tongue configured on the fastening body, wherein the fastening tongue includes a cutout; and
a lug configured on an outer side of the connector body, wherein in the installed state the lug engages into the cutout in such a way that the fastening body that at least in portions circumferentially surrounds the outer side of the connector body is immobilized on the connector body.

10. An injection system, comprising:
at least one fluid-conveying component;
at least one metering valve; and
at least one mounting system that includes:
a connector piece of the metering valve,
a connector body of the component, wherein in an installed state, the connector piece is inserted, along a longitudinal axis predefined by a receiving space of the connector body of the component, at least partly into the receiving space of the connector body of the component,
a support part disposed on the connector piece,
a decoupling element,
an abutment body, and
a fastening body, wherein the connector piece of the metering valve is mounted on the connector body in the installed state via the support part, the decoupling element, the abutment body, and the fastening body, wherein the abutment body is retained by the fastening body in such a way that the abutment body is movable radially with respect to the longitudinal axis at least in a context of installation relative to the fastening body,
wherein the metering valve is mounted on the fluid-conveying component via the mounting system.

11. The mounting system as recited in claim 1, wherein the injection system is a fuel injection system.

12. The mounting system as recited in claim 1, wherein the metering valve is a fuel injection valve.

13. The mounting system as recited in claim 4, wherein the fastening body segments include fastening body halves.

14. The mounting system as recited in claim 5, wherein the retaining element includes a fastening ring.

15. The injection system as recited in claim 10, wherein the injection system is for a mixture-compressing spark-ignited internal combustion engine.
